(19) United States
(12) Patent Application Publication
(10) Pub. No.: US 2005/0142482 A1
(43) Pub. Date: Jun. 30, 2005

(54) Photoresist for spacer and manufacturing method of liquid crystal display using the same

(76) Inventors: Kyung-Lae Rho, Suwon-si (KR); Hyo-Hwi Choi, Suwon-si (KR); Jin-Ho Ju, Seoul (KR)

Correspondence Address: MCGUIREWOODS, LLP, 1750 TYSONS BLVD, SUITE 1800, MCLEAN, VA, 22102, US

(21) Appl. No.: 11/002,653

(22) Filed: Dec. 3, 2004

(30) Foreign Application Priority Data
Dec. 8, 2003 (KR) 10-2003-0088548

(51) Int. Cl. G03C 1/76

(52) U.S. Cl. 430/270.1

(57) ABSTRACT

The present invention provides a photoresist for a spacer comprising: a copolymer, a multi-functional monomer, and a photoinitiator as a basic composition; and a solvent which includes at least one of MEC, PGMEA and DEME, and EEP. The solvent of the photoresist may further include n-BA, and additionally include a silicone based surfactant. Here, the solvent preferably includes 5-45% of EEP and 1%-30% of n-BA.

### BACKGROUND OF THE INVENTION

1. Field of the Invention

The present invention relates to a photoresist for a spacer and a manufacturing method of a liquid crystal display using the same.

2. Description of the Related Art

Generally, a liquid crystal display (LCD) consists of two substrates between which a liquid crystal having dielectric anisotropy is injected. The LCD displays images by applying voltages to the field-generating electrodes to generate an electric field and control incident light into the substrates by adjusting the intensity of the electric field.

The LCD includes two substrates provided with electrodes, and liquid crystal material injected between the two substrates. The two substrates are assembled together with a sealant, and the gap between the two substrates is maintained with the support of spacers distributed therebetween.

The manufacturing method of a LCD is as follows. At first, an alignment layer is coated and an alignment treatment is done to subsequently align the liquid crystal molecules on the substrates. Thereafter, circle-shaped substrate spacers are deposited onto one substrate and a sealant having liquid crystal inlet is printed thereon. Then, after aligning the two substrates and adhering them through a hot press process, the liquid crystal material is injected into the gap between the two substrates through the liquid crystal inlet and a liquid crystal cell is made by sealing the liquid crystal inlet. Here, within the display area shown as a screen, the spacers for maintaining the gap between substrates are additionally sprayed or the substrate spacers are formed through a photolithography process, while other spacers are added in the sealant to maintain the distance of the substrates.

As the size of the liquid crystal display increases, it becomes more important to develop the process of maintaining the gap between the two substrates uniformly.

### SUMMARY OF THE INVENTION

The technical purpose of the present invention is to provide a manufacturing method of a liquid crystal display for making a distance between two substrates uniform. Another technical purpose is to provide a photoresist to form a uniform spacer.

To achieve these purposes, the present invention provides a photoresist for a spacer that comprises a copolymer, a multi-functional monomer, and a photoinitiator as a basic composition, and it further comprises a solvent including at least one of MEC, PGMEA and DEME, and EEP.

The photoresist may further comprise a solvent additionally including n-BA and a silicon based surfactant. Here, the solvent preferably contains 5%-45% of EEP and 1%-30% of n-BA.

A process of forming a spacer according to the present invention comprises steps of (1) forming a photoresist film by coating a photoresist on substrates wherein the photoresist comprises a copolymer, a multi-functional monomer, and a photoinitiator as a basic composition, and it further comprises a solvent including at least one of MEC, PGMEA and DEME, EEP; (2) exposing the photosensitive film; and (3) developing the photoresist film to form a spacer.

### BRIEF DESCRIPTION OF THE DRAWINGS

Preferred embodiments of the present invention can be understood in more detail from the following descriptions taken in conjunction with the accompanying drawings, in which:

FIG. 1 is a layout view of a liquid crystal display according to an embodiment of the present invention;

FIG. 2 is a sectional view of a liquid crystal display taken along the line II-II′ of FIG. 1 according to an embodiment of the present invention;

FIG. 3 is a sectional view of a liquid crystal display taken along the line II-II′ of FIG. 1 according to another embodiment of the present invention;

FIG. 4 is a layout view of a spacer of a liquid crystal display according to an embodiment of the present invention;

FIG. 5 is a sectional view of the intermediate steps of forming a spacer of a liquid crystal display according to an embodiment of the present invention;

FIG. 6 is a sectional view of the intermediate steps of forming a spacer of a liquid crystal display according to another embodiment of the present invention.

### DETAILED DESCRIPTION OF THE PREFERRED EMBODIMENTS

Preferred embodiments of the present invention will now be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

Now, the structure of a finished liquid crystal panel for a liquid crystal display according to embodiments of the present invention will be briefly described.

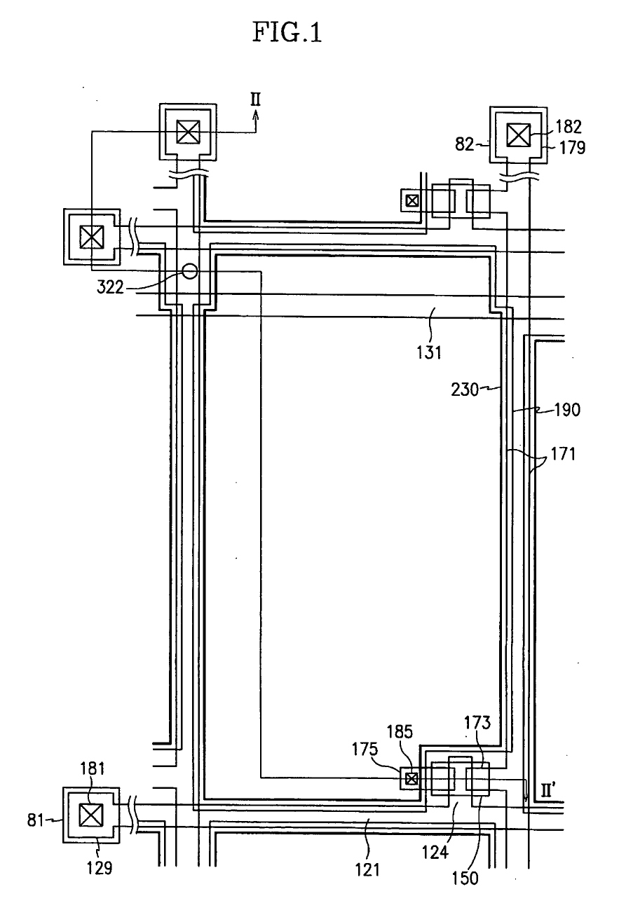

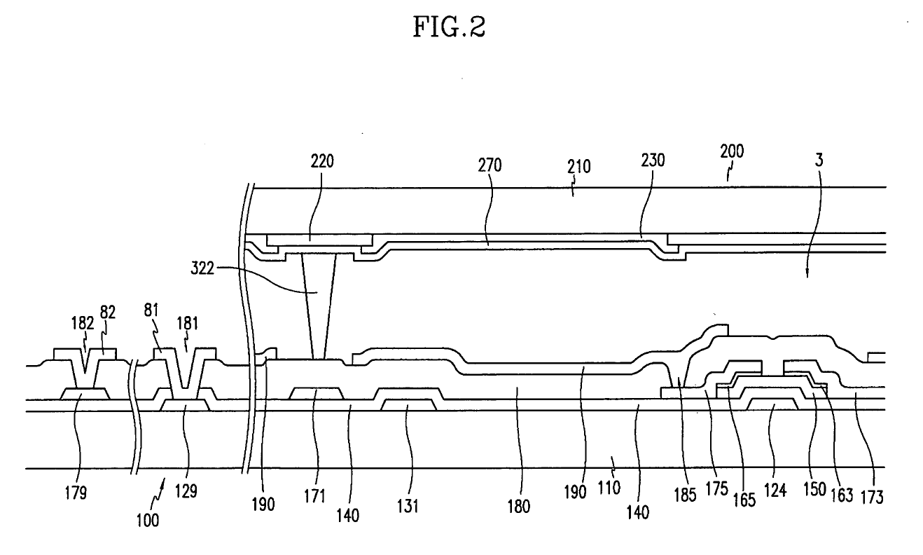

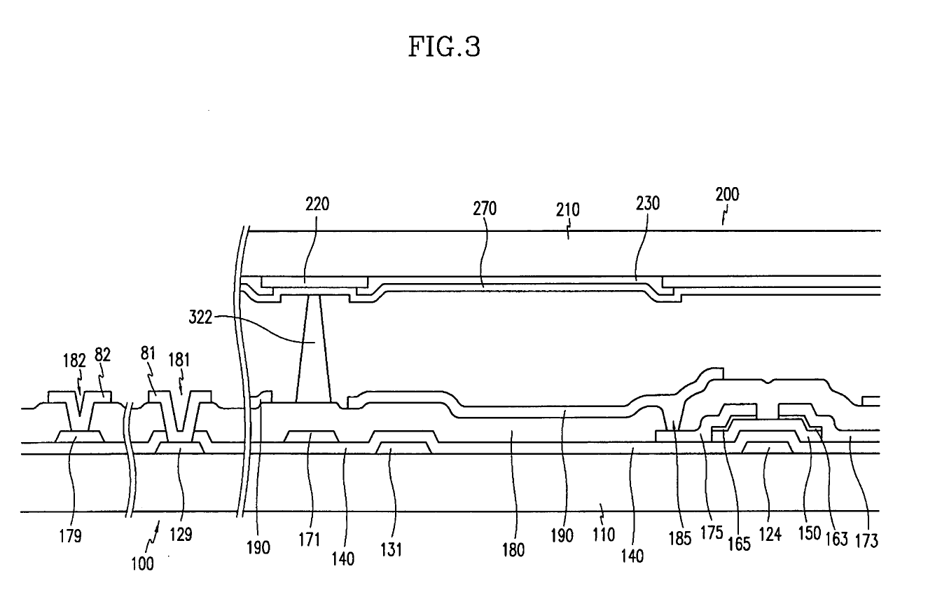

FIG. 1 is a layout view of a liquid crystal display according to an embodiment of the present invention, FIG. 2 is a sectional view of a liquid crystal display taken along the line II-II′ of FIG. 1 according to an embodiment of the present invention, and FIG. 3 is a sectional view of a liquid crystal display taken along the line II-II′ of FIG. 1 according to another embodiment of the present invention.

First, a structure of a thin film transistor array panel 100 will be explained.

On the insulating substrate 110, a gate line 121 having a conductive film made of low-resistance conductive materials, and a storage electrode line 131 are formed in a taper structure. The gate line 121 extends in a transverse direction. The gate line 121 has an end portion 129 to contact with the external circuit and to transmit a gate signal applied from the external circuit to the gate line 121 and gate electrodes 124 of thin film transistors. In this embodiment, the storage electrode line 131 is additionally formed for enhancing capability of preserving a pixel voltage, but the gate line 121 can be used as an electrode of a storage capacitor for enhancing capability of preserving a pixel voltage by overlapping with the pixel electrodes 190 of next pixel row. In the case of a lack of capability of preserving a pixel voltage, a separate storage line may be additionally formed.

On the substrate 110, the gate line 121 is covered by a gate insulating layer 140 made of SiNx or the like.

A semiconductor stripe 150, preferably made of hydrogenated amorphous silicon (abbreviated to “a-Si”), is formed on the gate insulating layer 140 and disposed above the gate electrode 124. Ohmic contact assistants 163 and 165, preferably made of silicide or n+ hydrogenated a-Si heavily doped with n type impurities, are formed on the semiconductor stripe 150.

A data line 171 which includes a conductive film made of low-resistance conductive materials is formed on the ohmic contact assistants 163 and 165 or the gate insulating layer 140. The data line 171 for transmitting data voltages extends substantially in the longitudinal direction and intersects the gate lines 121. The data line 171 includes an end portion 179 for contact with another layer or an external device, and a source electrode 173 which projects toward the upper part of ohmic contact layer 163. A drain electrode 175 is formed on the ohmic contact assistant 165 to face the source electrode 173 at the upper portion of the gate electrode 124. A conductive piece overlapping the storage electrode line 131 to enhance the storage capacity and electrically connected to the pixel electrode 190 may be formed.

A passivation layer 180 is formed on the data line 171. The passivation layer is made of an organic material having a good planarization characteristics and photosensitivity or an insulating material having a low dielectric constant such as a-Si:C:O:H.

Here, the passivation layer 180 may be made of an organic insulating material such as resin. In that case, it is desirable to prevent the semiconductor stripe 150 from contacting the organic insulating layer directly by adding an inorganic insulating layer such as SiNx layer under the organic insulating layer.

In addition, it is desirable to remove the passivation layer 180 completely at the end portion 129 of the gate line and at the end portion 179 of the data line. The method is particularly useful when it is applied in the LCD of the COG (chip on glass) method.

The passivation layer 180 has the contact holes 182 and 185 respectively exposing the drain electrode 175 and the end portion 179 of the data line. A contact hole 181 penetrating the passivation layer 180 and the gate insulating layer 140 exposes the end portion 129 of the gate line.

A pixel electrode 190 made of a transparent conductor such as ITO (indium tin oxide) or IZO (indium zinc oxide) is formed on the passivation layer 180. The pixel electrode 190 is electrically connected to the drain electrode 175 through the contact hole 185. Also, a gate contact assistant 81 and a data contact assistant 82, which are respectively connected to the end portion 129 and the end portion 179 through the contact holes 181 and 182, are formed in the passivation layer 180. Here, the gate contact assistant 81 and the data contact assistant 82 are provided to protect the end portions 129 and 179, but they are not requisite.

Meanwhile, a color filter panel 200 facing a thin film transistor array panel 100 includes a transparent insulating substrate 210 and a black matrix 220 formed on the transparent insulating substrate 210 and having openings at pixel areas. Red, green, and blue color filters 230 are sequentially formed at each pixel area. A common electrode 270 facing the pixel electrode 190 is formed all over the color filters to produce an electric field for driving liquid crystal molecules of the liquid crystal layer 3 along with the pixel electrode 190.

Between the two panels 100 and 200, the liquid crystal layer 3 is interposed, and a spacer is formed to keep the distance between two panels 100 and 200 uniformly.

The liquid crystal molecules of the liquid crystal layer 3 have a positive dielectric anisotropy with a twisted nematic mode spirally aligned from one substrate to the other substrate in which the two substrates are parallel with each other. However, the liquid crystal molecules may have a negative dielectric anisotropy and be vertically aligned to the two substrates. Also, the liquid crystal molecules may be in an OCB (optically compensated bend) mode at which they are aligned to form a symmetrical curve with respect to the center of the two substrates.

In the liquid crystal display according to an embodiment of the present invention, spacers 322 are formed on the color filter panel 200, but the spacers also can be formed on the thin film transistor array panel 100 as shown in FIG. 3.

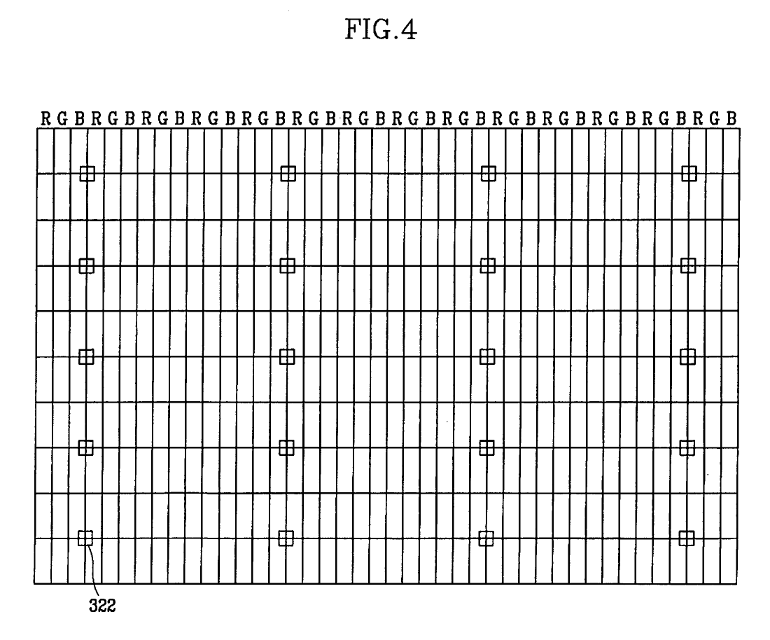

Here, although spacers 322 are located at the upper portions of the data line 171, they can be also located at the upper portions of the gate line 121 or the thin film transistor. It is preferable that the spacers are located at places covered by the black matrix 220 and disposed to have a uniform distance among them. As shown in FIG. 4, the spacers 322 are placed between the blue color filters 230B and the red color filters 230R to have a uniform distance among them.

In addition, the spacers 322 have the same height within an error range of ±300A.

In the following, the manufacturing method of a liquid crystal panel for a liquid crystal display will be described according to an embodiment of the present invention.

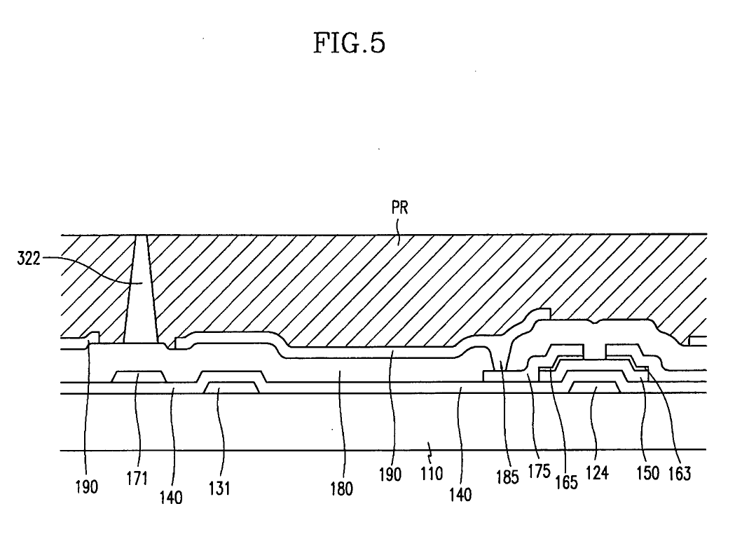

FIG. 5 is a sectional view of intermediate steps of forming a liquid crystal display spacer according to an embodiment of the present invention.

First, gate lines and data lines having low resistance, thin film transistors, and pixel electrodes of a transparent conductor or a conductor having good light reflectivity are formed in an insulating substrate 110 of a liquid crystal panel.

Next, a photoresist film PR is spin-coated in a predetermined spin speed. The photoresist film is made of a negative photoresist including an acrylic copolymer as a binder, an acrylic monomer as a multi-functional monomer, and a photoinitiator. In addition, the negative photoresist includes a solvent containing 5%-45% of EEP (ethyl-3-ethoxy propionate), 1%-30% of n-BA (normal-butyl acetate), and 55%-95% of one of MEC (methyl ethyl carbitol), PGMEA (propylene glycol monomethyl ether acetate), and DEME (diethylene glycol dimethyl ether) or a mixture thereof. The negative photoresist also includes a silicon based surfactant. Here, it is preferable that the amounts of the EEP and n-BA are respectively 30% and 5%.

Next, as shown in FIG. 5, the photoresist film is selectively exposed to a light to form polymers in portions where the spacer 322 will be formed and to remain monomer state in the other portions.

Next, the exposed photoresist film is developed to form the spacers 322.

Although there are many processes undertaken during exposing and developing, we will leave out detail explanations thereof because they are well-known to one skilled in the art to which the present invention pertains.

When the spacers 322 are formed by a photo process, the spacers 322 can be uniformly disposed and be prevented from being located on the light transmittance area of pixels. Accordingly, the uniformity of the cell gap and the display characteristics of the liquid crystal display are enhanced. Moreover, EEP and n-BA in MEC, and a silicone based surfactant enable forming the spacer to have a uniform height.

Next, the sealant 310 is coated on the thin film array panel 100 on which the spacers 322 are formed. The sealant 310 has a form of a closed curved without a liquid crystal inlet, and it is formed of a curing material cured by a heat or an ultraviolet. The sealant 310 may include spacers to maintain the distance between the two panels 100 and 200.

Since the sealant 310 does not have the liquid crystal inlet, it is important to control the amount of liquid crystal material in exact. To solve the problem that occurs when the amount of liquid crystal is too little or too much, it is preferable that the sealant has a buffer area which is not filled with liquid crystal materials even after the panels assembly is completed. Meanwhile, the sealant 310 preferably has a reaction prevention layer on the surface so as to prevent reaction with the liquid crystal layer 3.

Next, the liquid crystal material is coated on the array panel 100 using a liquid crystal coater. The liquid crystal coater may have a form of syringe for dropping the liquid crystal on the liquid crystal cell area or may have a form of spray spreading the liquid crystal material on the entire liquid crystal cell area.

Next, the two panels 100 and 200 are transferred into an assembling device including a vacuum chamber and are tightly attached to each other. After that, the vacuum of the chamber is removed to air-press the two panels 100 and 200 for adjusting the cell gap between the two panels 100 and 200. Then, the two panels 100 and 200 are completely assembled by curing the sealant through illuminating an ultraviolet ray or heating. Here, it is preferable that the two panels 100 and 200 are delicately aligned during the processes of attachment of two panels and illuminating an ultraviolet ray to the sealant.

Next, the liquid crystal panel is separated into the liquid crystal cells using a cutting device.

This invention can be applied not only to an LCD manufacturing method with the drop filling method as suggested in the described embodiment, but also to an LCD manufacturing method using an injection method.

In the injection method, the sealant is coated to have an inlet on one of the two panels 100 and 200, and the two panels 100 and 200 are attached together. Next, in a vacuum chamber, the panel's inlet is put into the liquid crystal material, and the liquid crystal is injected by removing the vacuum. After the filling of liquid crystal is completed, the inlet is sealed.

Next, we will provide an explanation of the LCD manufacturing method according to another embodiment.

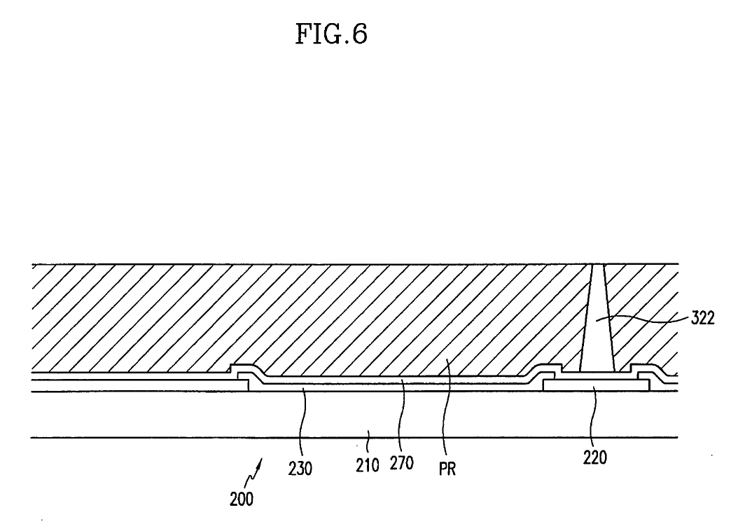

FIG. 6 is a sectional view of steps for forming a spacer of a liquid crystal display according to another embodiment of the present invention.

After sequential forming of a black matrix 220, color filters 230, and a common electrode 270 on the insulating substrate 210, the photoresist film (PR) is coated on the common electrode 270. The photoresist film is made of a negative photoresist including an acrylic copolymer as a binder, an acrylic monomer as a multi-functional monomer, and a photoinitiator. In addition, the negative photoresist includes a solvent containing 5%-45% of EEP (ethyl-3-ethoxy propionate), 1%-30% of n-BA (normal-butyl acetate), and 55%-95% of one of MEC (methyl ethyl carbitol), PGMEA (propylene glycol monomethyl ether acetate), and DEME (diethylene glycol dimethyl ether) or a mixture thereof. The negative photoresist also includes a silicon based surfactant. Here, it is preferable that the amounts of the EEP and n-BA are respectively 30% and 5%.

Next, as shown in FIG. 6, the photoresist film is selectively exposed to a light to form polymers in portions where the spacer 322 will be formed and to remain monomer state in the other portions.

Next, the exposed photoresist film is developed to form the spacers 322.

After that, a LCD cell is manufactured through processes such as forming a sealant, coating a liquid crystal layer, assembling the upper and lower array panels, and cutting into cells.

As suggested in the embodiments, the uniformity of the height of the spacers can be enhanced by forming the spacers with a photoresist including a solvent which contains EEP, n-BA, and one of MEC, PGMEA, DEME, and a mixture thereof and a silicone based surfactant.

The effects of the present invention will be described with experimental data.

The Table shows the uniformity of four sorts of spacers A, B, C, and D formed with different photoresists including different solvents and surfactants. The four photoresists have the same acrylic resin, monomer, and photo-initiator.

The measurements were accomplished by forming the spacers on an ITO layer which is deposited on a glass substrate having 300 mm×400 mm area. The other conditions of the exposure, development, and baking were the same. The heights of 12 points on the glass substrate were measured three times per each point. The maximum value of each point were used to calculate the mean, minimum (Min), and maximum (Max) value, as well as the uniformity of the 12 points. Here, the uniformity (U/F) was derived from following equation.

TABLE

| | | | A | B | C | D |
|---|---|---|---|---|---|---|
| | | 700 rpm, | 820 rpm, | 820 rpm, | 700 rpm, | 700 rpm, |
| | | 5″/10″/5″ | 3″/8″/3″ | 3″/8″/3″ | 5″/10″/5″ | 5″/10″/5″ |
| Solvent | | DEME 60% | MEC 100% | MEC 70% | MEC 65% | MEC 70% |
| | | PGMA 40% | | EEP 30% | EEP 30% | EEP 30% |
| | | | | | n-BA 5% | |
| Additive | | | F based | F based | F based | Si based |
| | | | surfactant | surfactant | surfactant | surfactant |
| height | Mean (um) | 3.370 | 2.728 | 2.730 | 3.036 | 3.138 |
| | Min (um) | 3.318 | 2.617 | 2.692 | 3.005 | 3.102 |
| | Max (um) | 3.427 | 2.813 | 2.796 | 3.107 | 3.192 |
| | U/F (%) | 1.616 | 3.610 | 1.896 | 1.669 | 1.430 |

As shown in the above table, the spacers B which are formed with a photoresist including a solvent containing MEC and 30% of EEP shows an improved uniformity than the spacers A which are formed with a photoresist including a solvent containing MEC only. The spacers C which are formed with a photoresist including a solvent additionally containing 5% of n-BA have more uniform height than the spacers B. In addition, the spacers D which are formed with a photoresist including a silicon based surfactant have more uniform height than the spacers B which are formed with a photoresist including a fluorine based surfactant.

When we apply a standard height currently used for mass production by adjusting coating rpm, the spacers C and D have better uniformities than the average level.

As explained above, the uniformity of the height of the spacers can be enhanced by forming the spacers with a photoresist including a solvent which contains EEP, n-BA, and one of MEC, PGMEA, DEME, and a mixture thereof and a silicone based surfactant.

Although the present invention has been described herein with the reference to the accompanying embodiments, it is to be understood that the present invention is not limited to those precise embodiments, and that various changes and modifications may be affected therein by one of ordinary skill in the related art without departing from the scope or spirit of the invention.

1. A photoresist for a spacer, comprising:
a copolymer, a multi-functional monomer, and a photoinitiator as a basic composition; and
a solvent including EEP and at least one of MEC, PGMEA, and DEME.

2. The photoresist for a spacer of claim 1, wherein the solvent further includes n-BA.

3. The photoresist for a spacer of claim 2, further comprising a silicone based surfactant.

4. The photoresist for a spacer of claim 2, wherein the solvent includes 5%-45% of EEP and 1%-30% of n-BA.

5. The photoresist for a spacer of claim 1, further comprising a silicone based surfactant.

6. A manufacturing method of a liquid crystal display (LCD) comprising:
forming a photoresist film by coating a photoresist on a substrate wherein the photoresist comprises a copolymer, a multi-functional monomer, and a photoinitiator as a basic composition, and further comprises a solvent including EEP and at least one of MEC, PGMEA, and DEME;
exposing the photosensitive film; and
developing the photoresist film to form spacers.

7. The manufacturing method of the LCD of claim 6, wherein the solvent of the photoresist further includes n-BA.

8. The manufacturing method of the LCD of claim 7, wherein the photoresist further includes a silicone based surfactant.

9. The manufacturing method of the LCD of claim 7, wherein the solvent includes 1%-30% of n-BA and 5%-45% of EEP.

10. The manufacturing method of the LCD of claim 6, wherein the photoresist includes a silicone based surfactant.

11. The manufacturing method of the LCD of claim 7, wherein pixel electrodes and thin film transistors are formed on the substrate where the photoresist is coated.

12. The manufacturing method of the LCD of claim 7, wherein color filters and common electrodes are formed on the substrate where the photoresist is coated.
